(19) United States
(12) Patent Application Publication
(10) Pub. No.: US 2010/0013731 A1
(43) Pub. Date: Jan. 21, 2010

(54) Coaxial cable dipole antenna for high frequency applications

(76) Inventor: Harold James Kittel, Gainesville, FL (US)

Correspondence Address: HAROLD JAMES KITTEL, 3311 S.W. 62nd LANE, GAINESVILLE, FL, 32608, US

(21) Appl. No.: 12/386,042

(22) Filed: Apr. 14, 2009

Related U.S. Application Data
(60) Provisional application No. 61/135,417, filed on Jul. 21, 2008.

(51) Int. Cl. H01Q 1/50

(52) U.S. Cl. 343/850

(57) ABSTRACT

An HF dipole antenna apparatus is provided which uses a coaxial cable for both a radiating element and a transmission line. Coiling the coaxial cable and adding a capacitive reactance to form a parallel resonant circuit with the coaxial cable coil achieves the transition between the radiation element and the transmission line. This antenna includes an upper radiating element. The addition of traps and parallel resonant circuits can be made to provide multi-frequency operation. An antenna coupling network can be added that provides appropriate reactance to allow both shortening the length of the dipole and provides a significantly wider range of operating frequencies.

### CROSS REFERENCE TO RELATED APPLICATIONS

APPLICATION No. 61/135,417 FILED Jul. 21, 2008
INVENTOR: HAROLD JAMES KITTEL
CONTENT RELATIONSHIP: CONVERSION OF PROVISIONAL PATENT TO NONPROVISIONAL PATENT

### STATEMENT REGARDING FEDERALLY SPONSORED RESEARCH OR DEVELOPMENT

NOT APPLICABLE

### REFERENCE TO SEQUENCE LISTING, A TABLE, OR A COMPUTER PROGRAM LISTING COMPACT DISC APPENDIX

NOT APPLICABLE

### BACKGROUND OF THE INVENTION

High frequency (HF) portable communications systems operating on multiple frequencies through out the 2-30 Mhz frequency range typically use a vertically polarized quarter wave monopole antenna and associated counterpoise or ground plane. The ground plane requires multiple radial wires (as many as 16) or large metal surfaces to be completely effective. Such ground planes are difficult to properly install and difficult to maintain in harsh environments. This is particularly true in maritime applications where salt spray, mechanical stress and vibration occur. Corrosion and mechanical vibration degrade the electrical connections of the ground plane resulting in low “effective radiated power” or poor antenna performance.

Rather than using a monopole, a better choice would be to use a conventional dipole antenna, which does not require the use of a ground plane. This would eliminate the installation and maintenance issues discussed. However, a conventional dipole has a feed line dropping away at right angles from the antenna at a mid point, which would interfere with antenna functioning in portable installations since the antenna is oriented vertically.

A coaxial dipole antenna using the coaxial feed line as part of the antenna overcomes this feed line issue. Coaxially fed antenna systems incorporating a half wave dipole consisting of a quarter wave section axially aligned and center fed with coaxial cable are well known in the prior art. However such prior art antennas are lengthy and cumbersome at these frequencies, and generally do not provide for multiple frequency operation. There are no multiband band, coaxial cable antennas available commercially for this HF range.

### BRIEF SUMMARY OF THE INVENTION

The object of the present invention is to provide a high frequency (HF) coaxial cable dipole antenna with small size and capable of operating over multiple frequencies.

This antenna invention is a high frequency, dipole antenna where the signals are both injected and retrieved from the same end of the antenna. This is made possible by using a portion of the coaxial feed line as part of the active antenna. Reactive resonant elements are placed along the active antenna portion of the coaxial feed line to both electrically isolate the end of the active antenna from the remaining coaxial feed line and also to “load” the antenna so as to shorten its electrical length at lower operating frequencies. These reactive resonant elements provide parallel resonant circuits for each range of operating frequencies desired. This antenna can be shortened in length and used by placing a commercially available antenna coupling network at the input of the coaxial antenna to provide whatever reactance is required to account for the shortened length. The antenna lead-in then connects this antenna coupling network to the radio wave circuit.

This antenna invention has the advantage of being easily erected in a vertical configuration since the far end of the antenna can be attached to a higher support object. The radio wave circuit is attached to the other end of the antenna and remains near ground level. There is no obstructive feed line problem since the antenna is fed at the bottom end. Since this antenna is a dipole configuration, no ground plane is required. This solves the problem with existing antenna designs of installing and maintaining an effective counterpoise or ground plane. The various reactive resonant elements and the antenna coupling network allow the antenna to be used over multiple operating frequencies. The loading effect of the various reactive resonant elements and the use of the antenna coupling network also allow the dipole antenna to be shortened to significantly less than ½ wavelength, allowing installation in a limited space.

### BRIEF DESCRIPTION OF SEVERAL VIEWS OF THE DRAWING

FIG. 1 shows the basic invention in its simplest form.

FIG. 2 shows the basic invention with multi-frequency capability.

FIG. 3 shows a practical implementation of this invention.

FIG. 4 shows details of the parallel resonant circuit.

FIG. 5 shows details of the RF choke construction.

### DETAILED DESCRIPTION OF THE INVENTION

Referring to FIG. 1, the simplest embodiment of this invention will be used to help explain the invention concept. This embodiment would be a single band coaxial cable dipole antenna for the HF band. It consists of a quarter wavelength wire antenna element 1 connected to the center conductor of the coaxial cable 2. This connection forms the feed point 3 of the dipole antenna. A parallel resonant circuit 4 is placed a quarter wavelength from the feed point 3 along the coaxial cable 2. This parallel resonant circuit defines the electrical length of L2 by presenting high impedance at the resonant frequency and allowing a voltage node to form. An RF choke 6 made of ferrite sleeves is slid over the end of the coaxial cable 2, and the coaxial cable is then connected, to the radio wave circuit 5. The RF choke 6 reduces any chance of stray RF currents from flowing across the coaxial cable.

Referring to FIG. 1, it should be noted that at radio frequencies the outside surface of the coaxial cable shield is electrically independent of the inside surface of that same shield. Electrical currents traveling on the outside of the coax shield do not influence currents traveling on the inside of that shield. Therefore, the physical configuration or arrangement of the coaxial cable 2 has no affect on the transmission line characteristics. As a result, winding the coaxial cable into a coil to form an inductor and part of a parallel resonant circuit 4 has no effect on the power being transferred between the radio wave circuit 5 and the feed point of the antenna 3.

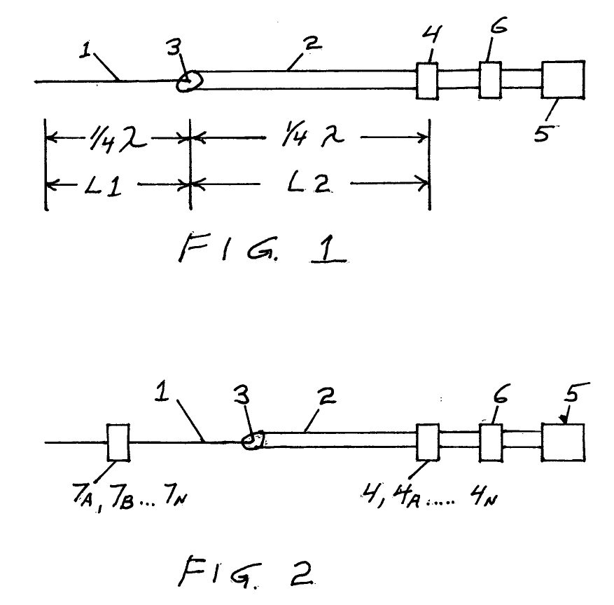

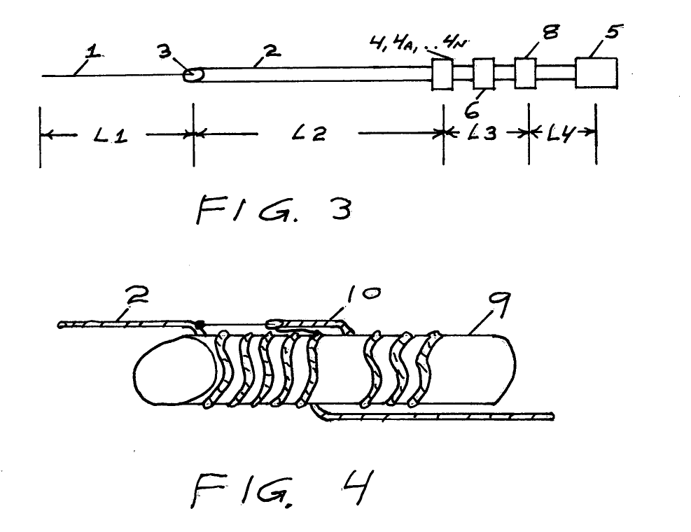

Referring to FIG. 2, additional operating frequencies can be added to this simplistic antenna shown in FIG. 1 by adding one or more traps (parallel resonant circuits) 7a, 7b . . . 7n each spaced an electrical quarter wavelength from the feed point 3 and by adding additional parallel resonant circuits 4a, 4b, . . . 4n each spaced an electrical quarter wavelength from the feed point 3 on coaxial cable 2. These traps and parallel resonant circuits resonate at approximately the frequency related to their respective electrical quarter wave length distance from the feed point 3.

The overall electrical length of this antenna would be one half wavelength at the lowest of frequencies to be operated. For practical purposes, in a limited space situation, that may be too long. For example, a half wave dipole antenna at 4 Mhz would be over 100 feet long and unwieldy in many applications. Therefore, the ability to shorten this antenna and the ability to provide many additional different operating frequencies is incorporated into the preferred embodiment of the patent, as detailed below.

Prior art examples of coaxially fed antenna systems incorporating a half wave dipole and consisting of a quarter wave section axially aligned and center fed with coaxial cable are well known. They are typically used in the cell phone service where half wave lengths are measured in inches and the antennas can be of miniature proportions. In these prior art examples, feed line isolation was typically achieved by means other than parallel resonant circuits. At HF frequencies half wavelengths are measured in feet and such prior art antennas would be lengthy and cumbersome. These antennas generally do not provide for multiple frequency operation. There are no multi band, coaxial dipole antennas available for this HF range.

The preferred embodiment of this antenna invention is discussed in the following paragraphs. The functional description is as follows:

Referring to FIG. 3, this invention incorporates an antenna coupling network 8, which may be either manual or automatic. (Devices of this nature are commercially available from communication equipment manufacturers and commonly used with antennas operating over multiple frequencies.) With this antenna coupling network 8, the two antenna legs corresponding to lengths L1 and L2 do not have to be equal in length and can be shorter than a quarter wavelength since the antenna coupling network will compensate by switching in the appropriate reactance to lengthen the antenna leg as needed. However, good engineering practice would suggest that L1 and L2 be of significant electrical length for good radiation efficiency. Length L3 is to be kept short because at certain some operating frequencies the standing wave ratio may be high, otherwise resulting in possible unwanted power loss. Length L4, which is the antenna lead-in may be as long as required.

Referring to FIG. 3, parallel resonant circuits 4, 4a, . . . 4n are placed in series on the coaxial cable 2 at quarter wave length distances from the feed point 3. As they resonate at the desired operating frequencies, these parallel resonant circuits provide the high impedance isolation required to define the electrical end of the antenna on the coaxial leg and prevent RF currents from flowing down coaxial cable. As a side benefit, these traps become inductive at frequencies below their resonance and “load” or lengthen the electrical length of the antenna.

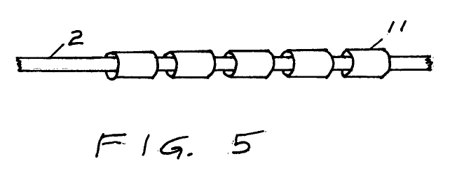

Referring to FIG. 4, appropriate diameter to length ratio of the coil form may be selected to obtain the proper “Q” factor to cover the range of operating frequencies desired. Typically smaller diameter and longer length inductor forms will yield lower “Q” factors resulting in wider bands of operating frequencies. Coil forms 9 should be typically in the range of 1-2 inches in diameter. The capacitive reactance required to resonate the coil can be obtained by connecting an appropriate length of unterminated coaxial cable across the start and finish windings of the coil as item 10 shows. The resonant frequency can be set approximately to the mid-point of the operating frequency range.

Referring to FIG. 3 an RF Choke 6 is placed between the last parallel resonant circuit and the antenna coupling network 8 to block any stray RF current from reaching the antenna coupling network or radio wave circuit 5.

The antenna invention assembly description is as follows:

Referring to FIG. 3, this antenna invention can be assembled in the following manner. Although shorter versions can be built, the preferred, more efficient version was built with an overall length of 44 feet and will be described here. This functioning prototype antenna has been built and tested to operate successfully on the 4 Mhz, 6 Mhz, 8 Mhz, 12 Mhz, 14 Mhz and 16 Mhz marine frequency bands. The finished length of L1 is 20 feet and length of L2 measured to the lowest frequency parallel resonant circuit of 4 Mhz is 24 feet. The antenna wire chosen for 1 was number 26 insulated, 37 strand. The coaxial cable used for 2 was RG-58, with a starting length of about 75 feet to allow sufficient cable for the coils to be formed for the multiple frequency bands required.

Referring to FIG. 4, the coax cable was wound into 3 coils to build 3 parallel resonant circuits to cover the above mentioned bands of operating frequencies. The parallel resonant circuits are constructed by winding the coaxial cable 2 around an insulated coil form 9 to form an inductor. The forms are approximately 1 inch in diameter and between 8 inches and 16 inches long, depending on the number of cable coil turns. The 4-5 Mhz coil required 46 turns, the 6-8 Mhz coil required 30 turns, and the 12-16 Mhz coil required 20 turns. Capacitive reactance is added to form a resonant circuit with the coil to resonate near the mid-point of the operating frequency ranges. This added capacitance may be obtained by using a section of un-terminated coaxial cable 10 and using the cable's intrinsic capacitance, which is about 20 pf per foot for RG-58. The center of the cable is connected to the start of the coil and the shield is connected to the finish of the coil. The 4-5 Mhz resonant circuit required approximately 4 feet of RG-58 cable, the 6-8 Mhz resonant circuit required 40 inches of RG-58 and the 12-16 Mhz resonant circuit required approximately 3 feet of RG-58 coax cable. The cable used as capacitance is stored by winding the excess adjacent to the coil on the same coil form 9. Correct resonance frequency should be checked with an RF bridge or a dip meter.

Referring to FIG. 5, the RF choke 6 consists of five ferrite sleeves 11, each about 1 inch in length and of the correct internal diameter to slip over the coaxial cable 2.

Referring to FIG. 3, the center conductor and shield conductor of the non-feed point end of the coaxial cable 2 was attached to the input terminals of an automatic antenna coupling network 8. The antenna coupling network out put was attached to the antenna lead in coax and routed to the radio wave circuit 5.

While only certain preferred features of this invention have been shown by way of illustration many modifications and changes will occur to those skilled in the art. It is, therefore, to be understood that the present claims are intended to cover all such modifications and changes as fall within the true spirit of the invention.

What is claimed is:

1. An antenna apparatus comprising:
An antenna element having a first electrical length and a feed point at an end of said antenna element;
a coaxial cable having an inner conductor, an end of said inner conductor being directly connected to said feed point, having a second electrical length from said feed point to a distance along the said coaxial cable where said coaxial cable is coiled around and attached to a cylinder of non-conductive material, placed in a series configuration in the said coaxial cable, and at the remaining end of said coaxial cable, both the said inner conductor and an adjacent shield conductor, is directly connected to a radio wave circuit; and
a capacitive reactance device is connected between start winding and finish winding of said coil where said coil and said capacitive reactance are electrically coupled together in parallel to form a parallel resonant circuit and resonate at the desired operating frequency, said first and said second electrical lengths are substantially a quarter wave length each, providing a dipole antenna structure resonating at one half wave length, related to the desired operating frequency.

2. The antenna apparatus of claim 1 comprising:
a parallel resonant trap circuit consisting of an inductive reactance and a capacitive reactance of suitable values electrically coupled together in parallel and mechanically stabilized in a form, for each additional operating frequency except the lowest frequency, placed in a series configuration and inserted into the said antenna element, situated at substantially an electrical quarter wave length, related to the said additional operating frequency, from the said feed point and resonating approximately at the said additional operating frequency; and
one additional said parallel resonant circuit for every said additional operating frequency and placed in a series configuration and inserted into the said coaxial cable situated at substantially an electrical quarter wave length, related to the said additional operating frequency, from said feed point and resonating approximately at the said additional operating frequency.

3. The antenna apparatus of claim 1 wherein:
Said remaining end of coaxial cable, both the said inner conductor and the said related shield conductor after being coiled, but before being directly connected to a radio wave circuit, be inserted thru hollow sleeves of a material capable of absorbing radio frequency current, and then both the said inner conductor and the said related shield conductor is directly connected to a radio wave circuit.

4. The antenna apparatus of claim 2 including:
Said remaining end of coaxial cable, both the said inner conductor and the said related shield conductor after being coiled, but before being directly connected to a radio wave circuit, be inserted thru hollow sleeves of a material capable of absorbing radio frequency current, and then both the said inner conductor and the said related shield conductor is directly connected to a radio wave circuit.

5. An antenna apparatus comprising:
An antenna element having a first electrical length and a feed point at an end of said antenna element;
a coaxial cable having an inner conductor, an end of said inner conductor being directly connected to said feed point, having multiple electrical lengths from said feed point to distances along the said coaxial cable where at each position said coaxial cable is coiled around and attached to a cylinder of non-conductive material, where one coil for each operating frequency range is placed in series configurations and inserted into the said coaxial cable, each situated at less than an electrical quarter wave length, related to the mid point of said operating frequency range, the remaining end of said coaxial cable consists of an inner conductor and an outer shield conductor;
a capacitive reactance device is connected between start winding and finish winding of each said coil where coil and capacitive reactance are electrically coupled together in parallel to resonate at mid point of each desired operating frequency range;
an antenna coupling network which co-operates with said first electrical length and the appropriate coaxial cable length to provide a dipole antenna structure resonating at the desired operating frequency, said antenna coupling network has an input which connects to said remaining end of the coaxial cable; and
an antenna lead-in connects the out put of the said antenna coupling network to a radio wave circuit.

6. Antenna apparatus of claim 5 including:
a parallel resonant trap circuit consisting of an inductive reactance and a capacitive reactance of suitable values electrically coupled together in parallel and mechanically stabilized in a form, for each additional operating frequency range except the lowest frequency, placed in a series configuration and inserted into the said antenna element, situated at less than an electrical quarter wave length, related to the said additional operating frequency, from the said feed point and resonating approximately at the midpoint of said operating frequency range.

7. Antenna apparatus of claim 5 including:
Said remaining end of said coaxial cable after being coiled, being inserted thru hollow sleeves of a material capable of absorbing radio frequency current, and then directly connected to the said input of the antenna coupling network.

8. Antenna apparatus of claim 5 including:
Said remaining end of said coaxial cable after being coiled, being inserted thru hollow sleeves of a material capable of absorbing radio frequency current, and then directly connected to the said input of the antenna coupling network.
